(19) United States
(12) Patent Application Publication
(10) Pub. No.: US 2010/0243796 A1
(43) Pub. Date: Sep. 30, 2010

(54) Plasma gun system utilizing an aerospace craft

(76) Inventor: Gary Richard Gochnour, Seattle, WA (US)

Correspondence Address: Gary Richard Gochnour, Apt, 426, 747 N. 135th St, Seattle, WA, 98133, US

(21) Appl. No.: 12/661,572

(22) Filed: Mar. 19, 2010

Related U.S. Application Data
(62) Division of application No. 11/728,080, filed on Mar. 23, 2007.
Application No. 11/728,080 is a continuation-in-part of application No. 11/137,643, filed on May 25, 2005, now abandoned.
Application No. 11/137,643 is a continuation-in-part of application No. 10/841,702, filed on May 6, 2004, now abandoned.
(60) Provisional application No. 60/468,598, filed on May 6, 2003.

(51) Int. Cl. B64C 39/00

(52) U.S. Cl. 244/62

(57) ABSTRACT

This invention relates to a plasma gun utilized in a plasma based aircraft maintained in a flight mode by rotating plasma vortices located above and beneath said aircraft. Plasma produced by aircraft is utilized by said plasma gun to facilitate initial take off of craft, and also to accelerate aircraft speed, or, within an emergency, as needed.

Said aircraft can also eject plasma through aircraft central shaft or within any direction from sides of said craft, for escape, evasion or normal accelerated flight.

Preferred embodiment for said plasma gun, is a coaxial plasma gun, utilizing the large capacitance potential of aircraft, the large supply of aircraft produced plasma off said capacitors, or from uninsulated conducting wires, and also utilizing the strong Lorentz force existing within craft.

The plasma produced by ionization within craft strong magnetic field, will enable this craft to rapidly avoid impediments to flight, or oncoming dangers.

### CROSS-REFERENCE TO RELATED APPLICATIONS

This application is a division of application Ser. No. 11/728,080, filed Mar. 23, 2007, by present inventor, now abandoned, which was a continuation in part of Ser. No. 11/137,643, filed May 25, 2005 by present inventor, now abandoned, which was a continuation in part of Ser. No. 10/841/702, filed 2004, May 6, by present inventor, now abandoned, which claims the priority to provisional patent application with Ser. No. 60/468,598, filed 2003, May 6, by the present inventor.

### BACKGROUND OF THE INVENTION

This invention relates to a plasma gun system utilizing an aerospace craft.

### SUMMARY OF THE INVENTION

In the present invention, an orbiting particle field, possessing a rotational direction for upward motional movement, will lift the aircraft off the ground or other surface, into the air, using a plasma gun, if necessary.

### BRIEF DESCRIPTION OF THE DRAWINGS

FIG. 9A shown is a cutaway top view of aircraft with a plasma gun ejecting plasma toward the rear of craft. Craft will be propelled in direction of arrows.

FIG. 9B shown is a cutaway top view of aircraft with a plasma gun. Plasma is being ejected into a central shaft, and out the bottom of craft. Craft will be propelled upward, away from earth.

FIG. 9C shown is a side view of aircraft. FIG. 9C is a side view of FIG. 9B. Plasma is shown ejected from bottom of craft. Craft will be propelled in direction of arrows, upward and away from the earth due to the ejected plasma.

### DESCRIPTION OF THE PREFERRED EMBODIMENT

### Operation of Plasma Gun

The operation of the device will be described first. This will be followed by a description of the preferred embodiment. The electrical system will impart increased energy to the plasma vortices, and with the plasma gun 9A, and through increased current through the annular bladed ring assembly 2, 2′, aircraft will accelerate in desired direction of travel.

This craft could use Martian atmosphere, C2O3, best with its plasma gun. The plasma gun assists propulsion as needed.

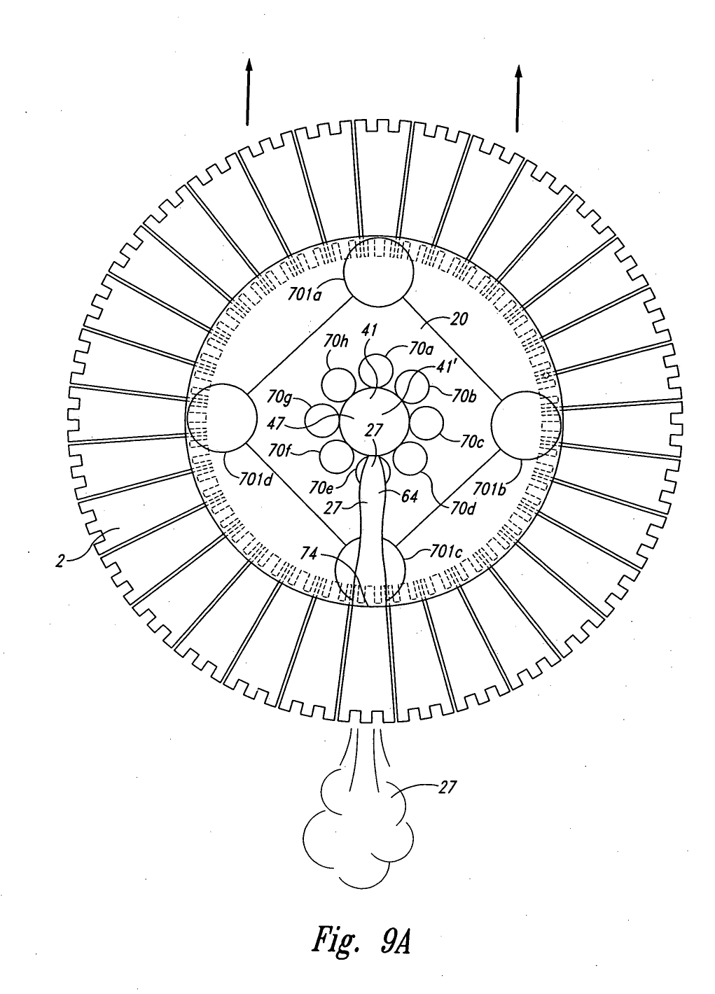

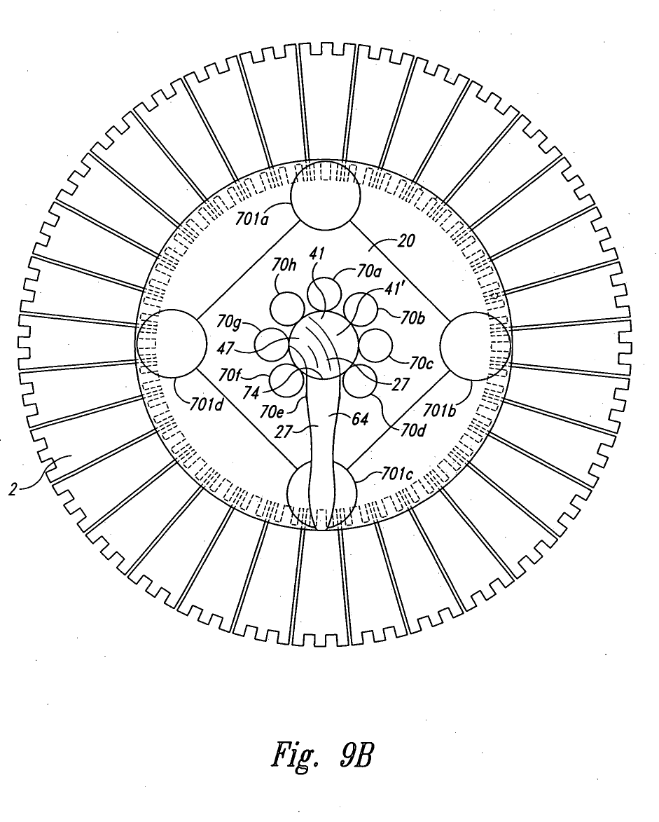

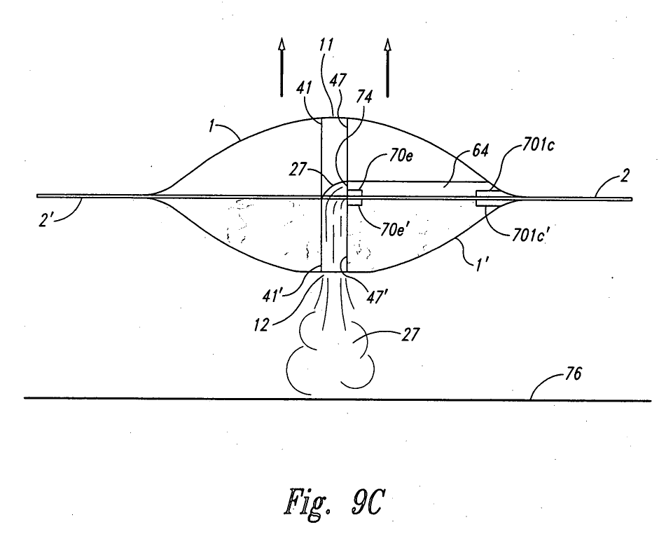

Said electromagnetic systems will be accompanied by plasma systems operating concurrently, said plasma systems include; said plasma utilized by a plasma gun 64, FIG. 9A, said plasma gun can also utilize plasma produced by said small capacitors encircling the central shaft 47, FIG. 9A, and the plasma produced by large capacitors.

The uninsulated annular ring 2, 2′, produces most plasma.

The plasma gun FIG. 9A and FIG. 9C, will have a large pulsed current, as the fluctuating direct current of the aircraft, with the large array of capacitors, produces a powerful plasma system for the plasma gun, also called plasma tube. Said plasma gun will produce plasma propulsion to extreme speeds. Said plasma tube with plasma from the annular ring, or from any capacitors, can be used for emergency flight in the event of failure of the plasma vortices. Flight to original destination can be maintained.

A plasma gun 64 will extend from one of the eight small capacitors 70a, 70b, 70c, 70d, 70e, 70f and 70h, surrounding the crew access tube 41, 41′, FIG. 5, to a position parallel with the middle of one of the large capacitors, and opposite to said small capacitor. Said large and small capacitors are connected by plasma moving through a plasma gun, and the electric field is at right angles to the magnetic field, as is the plasma gun, and the resulting Lorentz force will accelerate the flow of conducting plasma through said horizontal plasma gun.

Referring to FIG. 9B, the plasma gun 64, in FIG. 9B, has the plasma ejection end 74, pointing inward, towards the central shaft 41′, FIG. 5, and in a position to eject plasma 27, into the central shaft 41′. Said injected plasma exiting said central shaft on the bottom of hull 1′.

Referring to FIG. 9C, plasma 27, exiting from bottom of central shaft 41′, is indicated by ejected plasma cloud 27, FIG. 9C. Direction of movement of horizontal aircraft 1, 1′, or a larger aircraft B or C, is shown by arrows on top of depicted craft. Movement is in direction opposite from direction of ejected plasma 27, as indicated by directional arrows above craft.

Plasma 27, is shown being injected into the craft central shaft 41′ at midpoint of craft. Direction of plasma is reflected downward for said plasma being injected into central shaft 41′.

Said plasma will be repelled by the negative north pole in the upper part of the inductance coil 47 as said electric driven plasma has a dominating negative charge. At the same time, the plasma will be attracted by the positive south pole.

After being ejected into the central shaft 41, 41′, at midpoint in said shaft, the plasma from the plasma gun will be ejected from the bottom of inductance coil 47, 47′, having been further accelerated by the high electromagnetic energy in said coil.

The plasma gun plasma ejection end 74, can then be oriented to provide thrust from the side of aircraft between hull 1 and hull 1′, after the craft has ascended into the air, and propelling the craft in a lateral direction sideways horizontal or at an angle to earth.

In the event the surface of the earth has a negative charge, a possible, but unlikely event, the aircraft can be inverted, upside down. This would be the normal procedure if aircraft was already operational, however, in the event, the aircraft has not yet ascended, the plasma gun may be required for vertical ascent, unless said aircraft is highly charged.

The plasma gun will direct plasma into central shaft 41′, directed downward, and with craft motional direction for upward movement from said rotating plasma vortices on top and bottom of said aircraft, the craft will rise off the earth and become airborne.

Even though the plasma gun 64, enables the craft to operate at high energy levels, the aircraft is also being raised to high energy levels by the rotating plasma vortices increasing the craft ferromagnetism.

The plasma gun 74, FIG. 9C, will receive electric current, primarily a byproduct from the plasma process occuring on the uninsulated field windings around the blades in the bladed ring assembly 2, 2′, FIGS. 2 and 3.

The plasma gun is also receiving plasma from the capacitors as well as off the bladed ring assembly.

The plasma will be ejected from the bottom of central shaft 41, 41′, FIG. 5. Said bladed ring assembly will provide a large electric current within the conducting plasma moving through the plasma gun.

The conducting plasma is accelerated by the electric current and by a Lorentz force.

The conducting plasma is accelerated by the conducting current moving within the moving plasma in the plasma gun.

The plasma will be ejected from the bottom of the craft from the bottom of the central shaft, from the inductance coil.

Due to the large electric current moving through the plasma, and accelerating said plasma, the plasma ejected from the bottom of the craft will enable the craft to rise, and become airborne.

With the combination of the pulsed current from the large capacitor system, the large electric current from off the annular ring, and plasma from annular ring, craft will ascend.

The aircraft plasma gun will have a powerful plasma current due to the aircraft's vast array of capacitors, and the pulsed current from the aircraft fluctuating direct current, a pulsed current from the oscillatory circuit of the aircraft. Short bursts of high voltage, electric energy, can be provided to the plasma gun. Utilizing the Lorentz force, the craft will be propelled with extreme speed. The plasma tube 64, can be moved to all sectors around perimeter of the craft, or under craft.

End of operation section of preferred embodiment.

Beginning a description of the preferred embodiment.

Referring to FIGS. 9A, 9B, and 9C, a plasma gun 64, for plasma propulsion is shown in FIG. 9A. The plasma gun is also called plasma tube, exit 74 for plasma that has been accelerated is also shown. Eight small capacitors 70a, 70b, 70c, 70d, 70e, 70f, 70g, and 70h surround the central shaft 41, 41′. Said eight small capacitors are connected in parallel by said electric system 20, FIG. 4. One of the small capacitors, and a large capacitor opposite said small capacitor, on the same side of central shaft 41, 41′, will be connected by an intervening plasma gun 64. Plasma can exit said plasma gun from ejection end 74, as shown in FIG. 9A by said large capacitor. Plasma 27 will be ejected toward the rear of craft. Said craft will be propelled in the opposite direction, in direction as indicated by arrows. Or, plasma 27 can be ejected from ejection end 74, into said central shaft 41′, FIG. 9B.

Said plasma will exit from the bottom of craft. Craft will be propelled upward away from earth in direction as indicated in FIG. 9C. Due to the large and powerful array of capacitors, and due to a powerful pulsed current in the aircraft, and primarily due to the large amount of electric energy driven plasma off the annular ring of blades, plasma will be ejected from inductance coil.

For rapid egress from an area, an onboard plasma gun 64, can be used for propulsion. Said plasma gun can be moved to any location around the circumference of the submersible craft.

Said plasma gun can also be used to navigate the submersible craft.

End of description of the preferred embodiment for plasma gun

16. A method to accelerate plasma ejected into an inductance coil within an oscillatory circuit by a plasma gun with a large pulsed current, a Lorentz force, and, with a large supply of plasma from an annular ring of blades encircling said aircraft, also called ailerons, said conducting plasma also being accelerated by a large amount of electric current moving within the plasma, as a means to assist in lifting said aircraft off the earth, to become airborne, comprising:
(a) ejecting said plasma into said inductance coil, by means of said plasma gun, whereby,
(b) the north pole in said inductance coil will repel said conducting plasma, and
(c) the south pole will attract said conducting plasma, whereby,
(d) said plasma will be increasingly accelerated by said south pole attracting said conducting plasma, whereby,
(e) said plasma will be further accelerated by the negatively charged electromagnetic energy within said inductance coil, whereby,
(f) said accelerated plasma will be ejected from bottom of said craft with considerable force, and,
(g) said craft, assisted by craft lifting, rotating plasma vortices, and
(h) said craft assisted by plasma, accelerated by said inductance coil, and ejected with force, and
(i) said craft assisted by repulsive, positive south pole of craft, repulsing a positive charged earth, whereby,
(j) said craft will be enabled to lift off the earth, and become airborne.
